(19) United States
(12) Patent Application Publication
(10) Pub. No.: US 2003/0002540 A1
(43) Pub. Date: Jan. 2, 2003

(54) MPEG data packet transmission through an ATM network with jitter free decoding

(76) Inventors: Onno Eerenberg, Eindhoven (NL); Hendricus Antonius Johannes Marie Herijgers, Eindoven (NL)

Correspondence Address: U.S. Philips Corporation, 580 White Plains Road, Tarrytown, NY, 10591, US

(21) Appl. No.: 10/144,532

(22) Filed: May 13, 2002

(30) Foreign Application Priority Data
May 14, 2001 (EP) 01201800.8

(51) Int. Cl. H04J 3/06

(52) U.S. Cl. 370/518; 370/503

(57) ABSTRACT

Disclosed is a transmission system comprising a transmitter, a receiver and a transport network coupling the transmitter and the receiver. The transmitter is provided with time stamp means for generating respective transmission time stamps (TTS) representing a local clock based counting value included in a respective transport data stream (TS). The receiver is provided with a clock generator having a clock frequency control input. The receiver further comprises a time base regenerator coupled to the transport network for calculating a time difference between received successive transmission time stamps. The time base regenerator is coupled to the frequency control input for influencing the clock frequency based on said calculated time difference.

This way the reconstruction of an accurate time base is possible, resulting in a more reliable decoding process in the decoder of the receiver and a decreased vulnerability for jitter, such as introduced by an ATM type network.

The present invention relates to a transmission system comprising a transmitter, a receiver and a transport network coupling the transmitter and the receiver, whereby the transmitter is provided with time stamp means for generating respective transmission time stamps (TTS) representing a local clock based counting value included in a respective transport data stream (TS), and whereby the receiver is provided with a clock generator having a clock frequency control input.

The present invention also relates to a receiver for application in the transmission system.

Such a transmission system is known from U.S. Pat. No. 5,640,388. In the prior art transmission system data packets containing time stamps, here indicated PCR, are transmitted from transmitter through a transport network to receiver. The data packets form a coded representation of a video, audio and/or other transport data stream. Each data stream may have its own time base. For example a subscription TV system may comprise a video stream and an associated audio stream. These streams may be combined in a single, so called Moving Picture Expert Group (MPEG) type transport bit stream suitable for transmission through the transport network. Generally each data packet contains a header portion and a payload portion containing the encoded data of the stream concerned. Each group of transport stream packets that contains the same representation of coded data are assigned the same unique Packet Identifier (PID) included in the header portion.

The transmitter is provided with a time stamp means for generating so called Program Clock Reference (PCR) values, also included in a further header portion and originally derived from an actual time base of a counter coupled to a clock generator of an encoder present in the transmitter. These time stamp or PCR values can be adjusted to compensate for possibly variable delays experienced for example during a multiplexing at the transmitter or during transmission through the transport network. The PCR values which are sent periodically in the transmitted data packets can then be used to recover a clock generator signal at the receiver. In particular in an Asynchronous Transfer Mode (ATM) network, which allows a multiplexing of packets comprising different data representations, as allowed by the MPEG-1 or the MPEG-2 standard, temporal locations of the data stream packets may change in relation to their PCRs. This results in jitter experienced at the receiver and in that case the PCRs, which no longer reflect the proper time base, cannot be used to re-establish a reliable clock generator signal for the time base.

In this prior art document jitter is removed by correcting the PCR values in the received packets before decoding the data packets in a decoder which is present in the receiver. Thereto the received packets are stored in a buffer, while the buffer outputs the packets to the decoder at a nominal rate prescribed by the local receiver clock generator operating at a nominal frequency substantially equally to the clock frequency in the transmitter. The average transit time of the packets through the buffer is measured and used to modify the PCR values in the further header portion, such that jitter between associated packets is finally removed before they are fed to the decoder.

Its a disadvantage of the transmission system according to the prior art that the above elucidated PCR correcting measures result in a lot of calculating, bookkeeping per program and hardware required to operate on the PCR. As each program has its own different time base, more programs result in the involvement of even more processing and bookkeeping per program.

Therefore it is an object of the present invention to provide a transmission system presenting a stable and accurate time base for performing reliable decoding in the receiver, and notwithstanding allowing freedom of choice respecting the types of transmitters and receivers.

Thereto the transmission system is characterised in that the receiver further comprises a time base regenerator coupled to the transport network for calculating a time difference between received successive transmission time stamps, and coupled to the frequency control input for influencing the clock frequency based on said calculated time difference.

It is an advantage of the transmission system according to the present invention that, based on the calculated time difference between received successive transmission time stamps, a reconstruction of the time base in the receiver defined by the clock signal generator frequency, can be accomplished accurately. This is because the transmission time stamps accurately define the time base at the transmitter end, which time base can now easily and reliable be reconstructed at the receiver end. The increased accuracy of the time base thus results in a more reliable decoding process in the decoder of the receiver. In addition the proposed transmission system according to the invention results in a decreased vulnerability for jitter, such as introduced by a packet switched network, such as Ethernet or an ATM type network, because irrespective the jitter introduced by the transport network a reliable time base reconstruction can be achieved based on the calculated time stamp differences.

In addition only the receiver end of the transmission system according to the invention need to be technically adapted to the proposed solution, and existing MPEG transmitters can still be used, since the content of the transport data stream is not changed. In this respect the invention is transparent and receivers may be exchanged, whereas manufacturers of encoders and decoders may be different, as both are not bothered by the proposed solution. Furthermore it is an advantage that the PCR at the receiver end need not be changed.

An embodiment of the transmission system according to the invention is characterised in that the transmission system is provided with means to determine the correctness of the received data packets.

Advantageously this embodiment of the transmission system according to the invention allows the data packet to be transmitted through a network, containing satellite communication, terrestrial communication and/or fibre or cable communication, because any errors introduced by the transport network can generally be detected upon receipt and possibly be corrected.

A further embodiment of the transmission system according to the invention is characterised in that the transmission system is provided with means for determining the correctness of received transmission time stamp data. Preferably these means for determining are capable of performing a cyclic redundancy check over the received data packet and/or on the so called payload data in the packet.

Advantageously this check guarantees to a high degree the correctness of the actual data stream, as well as the correctness of the transmission time stamps data after transmission through the transport network.

A further embodiment of the transmission system according to the invention is characterised in that the indicating means are formed by a continuity count (CC), the transmission time stamp (TTS), and a data packet identifier (PID), whereby the CC and the PID are combined to form a label to the transmission time stamp.

Its an advantage of this further embodiment according to the present invention, that it allows a packet loss or a packet misalignment during transmission across the transport network to be noticed. The mechanism proposed here guarantees that at the receiver end the transmission time stamps refer to the correct transport stream packet.

At present the transmission system according to the invention and transmitter and receiver for application therein will be elucidated further together with their additional advantages, while reference is being made to the appended drawing, wherein similar components are being referred to by means of the same reference numerals.

In the drawing:

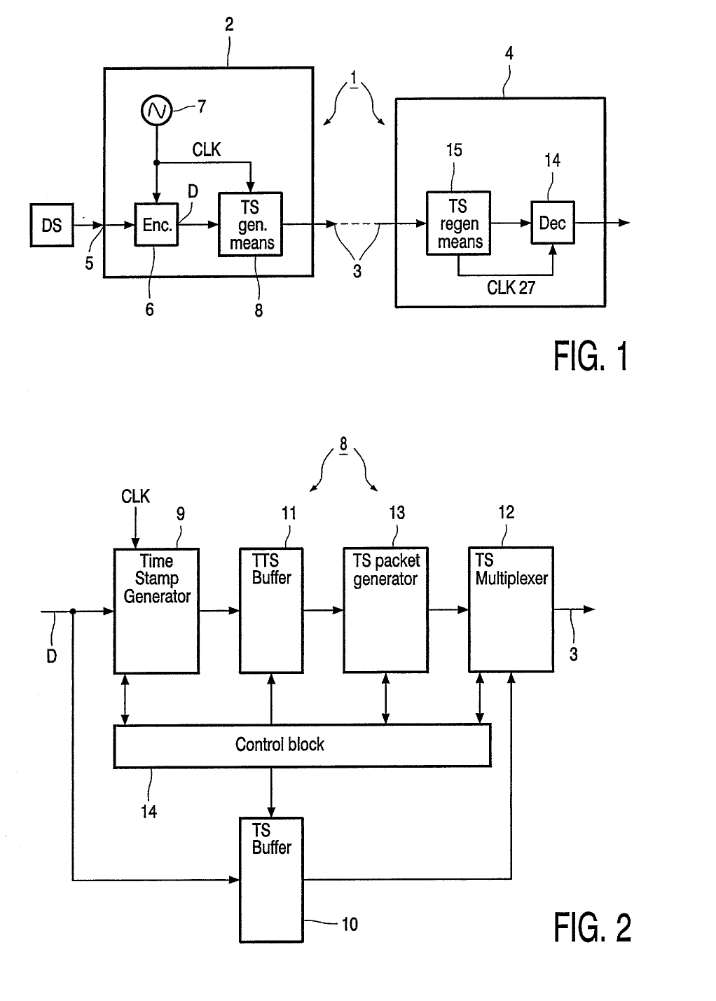

FIG. 1 shows an embodiment of the transmission system according to the invention;

FIG. 2 shows an embodiment of the time stamp generator means in the transmitter, which is suitable for application in the transmission system of FIG. 1; and

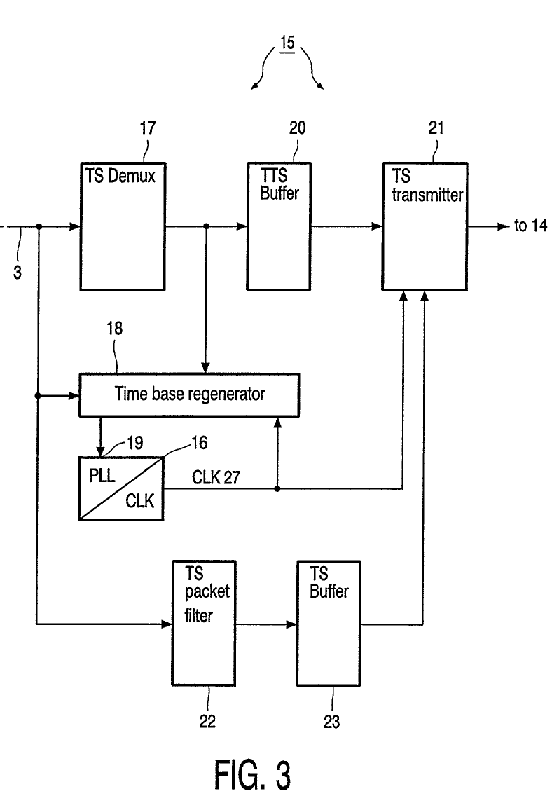

FIG. 3 shows an embodiment of the time stamp regenerator means in the receiver, which is suitable for application in the transmission system of FIG. 1.

FIG. 1 shows a transmission system 1 comprising a transmitter 2 coupled to a transport network or communication channel 3, and a receiver 4 coupled to the transport network 3. The transmitter 2 is capable of sending data, in the form of data packets through the network to the receiver 4. The transport network 3 may be a data packet switched network, containing for example a coax, fibre optical, satellite, beam connection or satellite communication link. The transmitter 2 has an input 5 which is coupled to a data source DS, for example in the form of a camera providing a data packet stream comprising a video payload and, possibly combined, a data packet stream comprising an audio payload. These packet streams may be separate or multiplexed data packet streams. Each data packet stream is transmitted to the receiver 4 in coded form. The transmitter 2 comprises an encoder 6 coupled to the input 5. The encoder may be an MPEG encoder 6 to provide video and/or audio transport data stream packets on its data output D for transmission through the network 3. The encoder 6 is coupled to a transmitter clock generator 7, usually generating a 27 MHz clock signal. The transmitter 2 is further provided with transmission time stamp generator means 8 coupled to the encoder 6 and to the clock generator 7.

Transmission time stamp generator means 8 are further shown in FIG. 2 and comprise a time stamp generator 9, which determines based on the local clock signal CLK, the local transmission time of every data transport stream (TS) to form generated transmission time stamps TTS of a transmitted data packet. These time stamps TTS may—as will be explained later—together with other kinds of header data be combined. Similarly the time stamps may be combined with the audio payload to form separate audio data packets, but the time stamps may also be combined such that a time stamp data packet contains a possible succession of time stamps, whereby each time stamp is related to respective transmission stream packets. After encoding in encoder 6 the various video and audio data form a transport stream, which is stored in TS buffer 10 coupled to encoder output D. Similarly the transmission time stamps TTS are stored in a TTS buffer 11 coupled to the time stamp generator 9. The transmitter 8 further comprises a possible TS multiplexer 12 coupled to the buffers 10 and 11 respectively in order to provide a full data signal for transmittal over the transport network 3. Possibly between the TTS buffer 11 and the TS multiplexer 12 there is coupled a TS packet generator 13 for combining several TTS data blocks, which may or may not be multiplexed with TS data from buffer 10. A usually programmable control block 14 is provided to control the proper sequence of events and operations in the transmitter 2.

The receiver 4, shown in FIG. 1, receives the full data signal in the form of data packets, which are transmitted over the network 3. The TS data packets are decoded by a decoder 14 to recover the video and audio signal originating from data source DS. Decoding takes place based on a local receiver clock signal CLK 27, which is recovered by means of well known PCR values in the transport stream, which PCR values are left unchanged.

The TS regenerator means 15, which are further detailed in FIG. 3, comprise a clock generator 16, usually in the form of a Phase Locked Loop (PLL) for providing the CLK 27 clock signal, which provides the time base for the dejitter function implemented at the receiver 4 in the TS regenerator means 15. For a reliable and accurate decoding in the decoder 14 it is important that the transmitter and receiver clock generators 7 and 16 respectively provide respective clock signals having frequencies matching as closely as possible, else the decoding will lead to data failures. This means that the time base at the receiver 4 has be recovered from the received data packets as accurate as possible.

The TS means 15 comprises a transport stream (TS) demultiplexer 17 for recovering the transmitted transmission time stamps TTS. These time stamps and in particular the difference between consecutive time stamps provides information about the clock frequency of the signal CLK at the transmitter 2. The time difference is calculated in a time base regenerator 18, which is coupled to the TS demultiplexer 17, and this time difference is being used to drive the clock generator 16 at its frequency control input 19. This results in a frequency control of the clock generator 16, such that its frequency closely matches the frequency of the clock signal CLK in the transmitter 2, which in turn results in an accurate and reliable time base for transmission of the TS data packets to the decoder 14. The transmission time stamps TTS may be buffered by buffer 20 before being fed to a transport stream provider 21. The transport stream TS data is derived from the network data packages through a TS packet filter 22 and then through a TS buffer 23 also fed to the transmitter 21 to provide the decoder input signal. Again the buffers 20 and 23 allow some delay arising between the processing of the transmission time stamps and the transport stream TS or payload data.

Generally in order to ensure reliable data packet communication over the transport network 3, some kind of check is performed at the network receiver 4 to determine the correctness of the received data. This is important because any mistake in a received transmission time stamp results in faulty data for generating the time base. A possible check is the cyclic redundancy check which is performed over the received data packet. Such a check is capable of indicating faulty data and/or capable of correcting the faulty data. If the faulty data cannot be corrected provisions will generally be taken to re-send the data packet concerned.

Preferably some form of indication means implemented in the TS transmitter 21 is provided to ensure that the transmission time stamp TTS received at the receiver 4 refers to its associated data packet. Such means or measures may be embodied by a label containing a continuity count CC, and a data packet identifier PID. If the CC and the PID are digitally combined to form a label then its value can be used as a reference to the main header portion of an associated transport stream packet. Misalignments, which are due to packet loss can thus be detected.

Whilst the above has been described with reference to essentially preferred embodiments and best possible modes it will be understood that these embodiments are by no means to be construed as limiting examples of the devices concerned, because various modifications, features and combination of features falling within the scope of the appended claims are now within reach of the skilled person.

1. Transmission system comprising a transmitter, a receiver and a transport network coupling the transmitter and the receiver, whereby the transmitter is provided with time stamp means for generating respective transmission time stamps (TTS) representing a local clock based counting value included in a respective transport data stream (TS), and whereby the receiver is provided with a clock generator having a clock frequency control input, characterised in that the receiver further comprises a time base regenerator coupled to the transport network for calculating a time difference between received successive transmission time stamps, and coupled to the frequency control input for influencing the clock frequency based on said calculated time difference.

2. The transmission system according to claim 1, characterised in that the transmission system is provided with means to determine the correctness of received transmission time stamp data.

3. The transmission system according to claim 2, characterised in that a cyclic redundancy check is performed over the received transmission time stamp data.

4. The transmission system according to one of the claims 1-3, characterised in that the transmission system is provided with means to indicate whether the transmission time stamp received at the receiver refers to its associated data packet.

5. The transmission system according to claim 4, characterised in that the indicating means are formed by a continuity count (CC), the transmission time stamp (TTS), and a data packet identifier (PID), whereby the CC and the PID are combined to form a label to the transmission time stamp.

6. A transmitter for application in the transmission system according to one of the claims 1-5, comprising the transmitter, a receiver and a transport network coupling the transmitter and the receiver, whereby the transmitter is provided with time stamp means for generating respective transmission time stamps (TTS) representing a local clock based counting value included in a respective transport data stream (TS), and whereby the receiver is provided with a clock generator having a clock frequency control input, characterised in that the receiver further comprises a time base regenerator coupled to the transport network for calculating a time difference between received successive transmission time stamps, and coupled to the frequency control input for influencing the clock frequency based on said time difference.

7. A receiver for application in the transmission system according to one of the claims 1-5, whereby the transmission system comprises a transmitter, the receiver and a transport network coupling the transmitter and the receiver, whereby the transmitter is provided with time stamp means for generating respective transmission time stamps (TTS) representing a local clock based counting value included in a respective transport data stream (TS), and whereby the receiver is provided with a clock generator having a clock frequency control input, characterised in that the receiver further comprises a time base regenerator coupled to the transport network for calculating a time difference between received successive transmission time stamps, and coupled to the frequency control input for influencing the clock frequency based on said time difference.

8. Signals for use in the transmission system according to one of the claims 1-5, comprising a transmitter, a receiver and a transport network coupling the transmitter and the receiver, whereby the transmitter is provided with time stamp means for generating respective transmission time stamps (TTS) representing a local clock based counting value included in a respective transport data stream (TS), and whereby the receiver is provided with a clock generator having a clock frequency control input, characterised in that the receiver further comprises a time base regenerator coupled to the transport network for calculating a time difference between received successive transmission time stamps, and coupled to the frequency control input for influencing the clock frequency based on said time difference.
